(19) United States
(12) Patent Application Publication
(10) Pub. No.: US 2002/0099736 A1
(43) Pub. Date: Jul. 25, 2002

(54) Method of storing a structured data document

(75) Inventors: Linda Lee Grimaldi, Colorado Springs, CO (US); Christopher Lockton Brandin, Colorado Springs, CO (US); Kevin Lawrence Huck, Woodland Park, CO (US)

Correspondence Address: Law Offices of Dale B. Halling, LLC, Suite 311, 24 S. Weber Street, Colorado Springs, CO, 80903, US

(73) Assignee: Neo-Core, L.L.C.

(21) Appl. No.: 09/768,102

(22) Filed: Jan. 23, 2001

(51) Int. Cl. G06F 17/22

(52) U.S. Cl. 707/513; 707/526

(57) ABSTRACT

A method of storing a structured data document includes the step of first flattening the structured data document to provide a plurality of tags, a data entry and a plurality of format characters in a single line. The plurality of tags, the data entry and the plurality of format characters are stored. Flattening the document generally significantly reduces the number of lines used to describe the document. In addition, a dictionary is created for the tags and the data entries. A map store only stores pointers to the tags and the data entries.

### RELATED APPLICATION

This patent application is related to the U.S. patent application Ser. No. 09/419,217, entitled “Memory Management System and Method” filed on Oct. 15, 1999, assigned to the same assignee as the present application and the U.S. patent application Ser. No. ?? (NEO-0003), entitled “Method and System for Storing a Flattened Structured Data Document” filed on Jan. 23, 2001, assigned to the same assignee as the present application and the U.S. patent application Ser. No. ?? (NEO-0004), entitled “Method Of Performing A Search Of A Numerical Document Object Model” filed on Jan. 23, 2001, assigned to the same assignee as the present application Ser. No. ?? and the United States patent application, (NEO-0005), entitled “Method of Operating an Extensible Markup Language Database” filed on Jan. 23, 2001, assigned to the same assignee as the present application.

### FIELD OF THE INVENTION

The present invention relates generally to the field of generally to the field of data storage and more particularly to a method of storing a structured data document.

### BACKGROUND OF THE INVENTION

Structured data documents such as HTML (Hyper Text Markup Language), XML (eXtensible Markup Language) and SGML (Standard Generalized Markup Language) documents and derivatives use tags to describe the data associated with the tags. This has an advantage over databases in that not all the fields are required to be predefined. XML is presently finding widespread interest for exchanging information between businesses. XML appears to provide an excellent solution for internet business to business applications. Unfortunately, XML documents require a lot of memory and bandwidth to transmit efficiently.

Thus there exists a need for a method of storing structured data documents that reduces the memory and bandwidth requirements associated with using these documents.

### BRIEF DESCRIPTION OF THE DRAWINGS

FIG. 1 is an example of an XML document in accordance with one embodiment of the invention;

FIG. 2 is an example of a flattened data document in accordance with one embodiment of the invention;

FIG. 3 is a block diagram of a system for storing a flattened data document in accordance with one embodiment of the invention;

FIG. 4 shows two examples of a map store cell in accordance with one embodiment of the invention;

FIG. 5 is a flow chart of a method of storing a structured data document in accordance with one embodiment of the invention;

FIG. 6 is a flow chart of a method of storing a structured data document in accordance with one embodiment of the invention; and

FIG. 7 is a flow chart of a method of storing a structured data document in accordance with one embodiment of the invention.

### DETAILED DESCRIPTION OF THE DRAWINGS

A method of storing a structured data document includes the step of first flattening the structured data document to provide a plurality of tags, a data entry and a plurality of format characters in a single line. The plurality of tags, the data entry and the plurality of format characters are stored. Flattening the document generally significantly reduces the number of lines used to describe the document. In addition, a dictionary is created for the tags and the data entries. A map store only stores pointers to the tags and the data entries. This significantly reduces the amount of memory necessary to store the document. Note that the invention will be described with respect to an XML (eXtensible Markup Language) document, but is generally applicable to any structured data document.

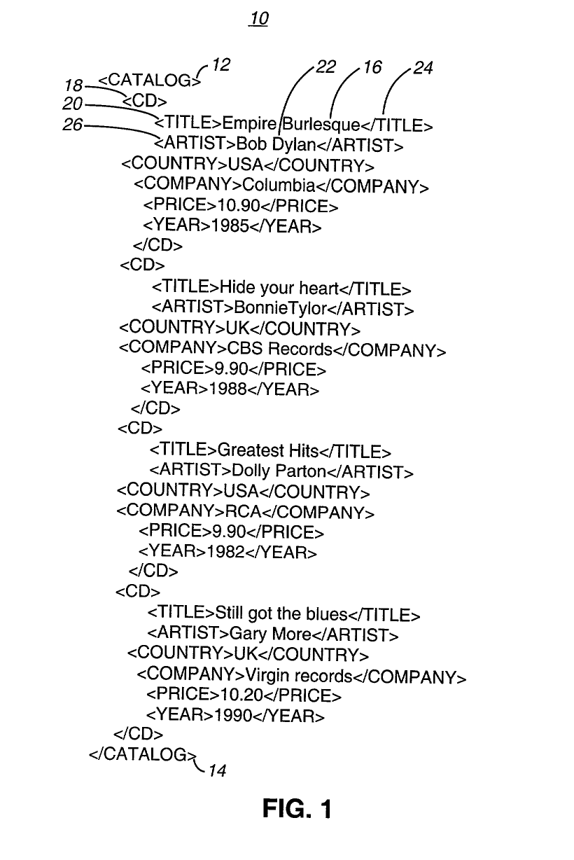

FIG. 1 is an example of an XML document 10 in accordance with one embodiment of the invention. The words between the < > are tags that describe the data. This document is a catalog 12. Note that all tags are opened and later closed. For instance <catalog> 12 is closed at the end of the document </catalog> 14. The first data item is “Empire Burlesque” 16. The tags <CD> 18 and <TITLE> 20 tell us that this is the title of the CD (Compact Disk). The next data entry is “Bob Dylan” 22, who is the artist. Other compact disks are described in the document.

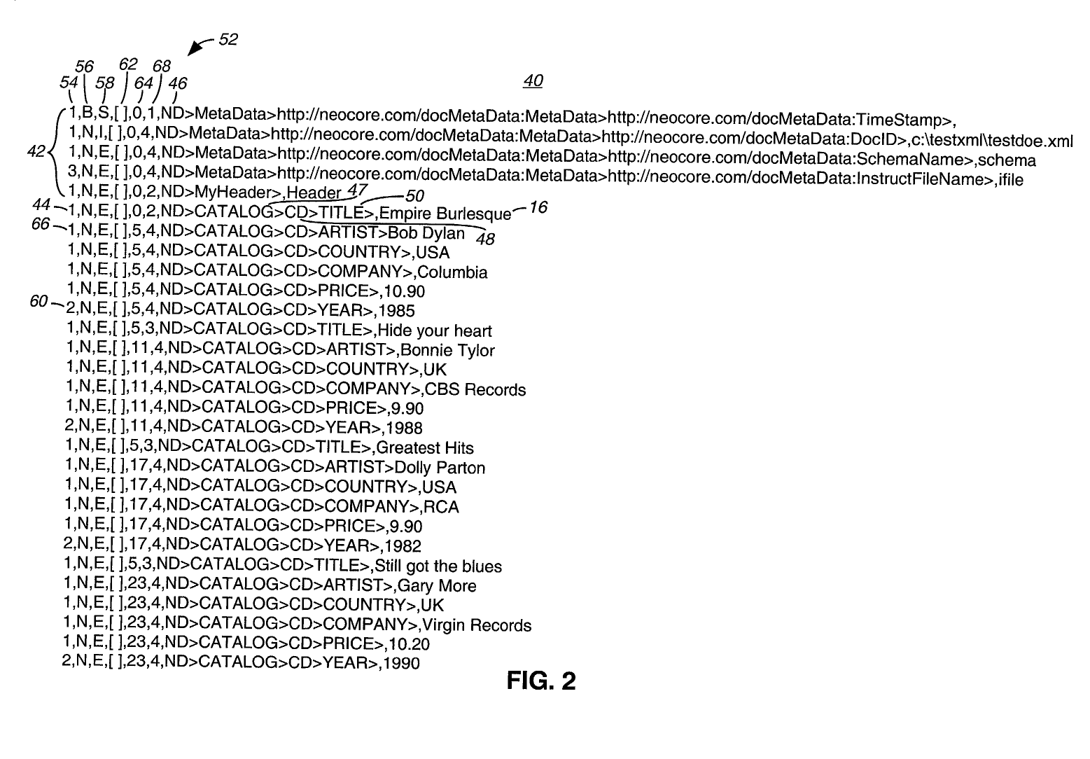

FIG. 2 is an example of a flattened data document 40 in accordance with one embodiment of the invention. The first five lines 42 are used to store parameters about the document. The next line 44 shows a line that has flattened all the tags relating to the first data entry 16 of the XML document 10. Note that the tag <ND> 46 is added before every line but is not required by the invention. The next tag is CATALOG> 47 which is the same as in the XML document 10. Then the tag CD> 48 is shown and finally the tag TITLE> 50. Note this is the same order as the tags in the XML document 10. A plurality of formatting characters 52 are shown to the right of each line. The first column is the n-tag level 54. The n-tag defines the number of tags that closed in that line. Note that first line 44, which ends with the data entry “Empire Burlesque” 16, has a tag 24 (FIG. 1) that closes the tag TITLE. The next tag 26 opens the tag ARTIST. As a result the n-tag for line 44 is a one. Note that line 60 has an n-tag of two. This line corresponds to the data entry 1985 and both the YEAR and the CD tags are closed.

The next column 56 has a format character that defines whether the line is first (F) or another line follows it (N-next) or the line is the last (L). The next column contains a line type definition 58. Some of the line types are: time stamp (S); normal (E); identification (I); attribute (A); and processing (P). The next column 62 is a delete level and is enclosed in a parenthesis. When a delete command is received the data is not actually erased but is eliminated by entering a number in the parameters in a line to be erased. So for instance if a delete command is received for “Empire Burlesque” 16, a “1” would be entered into the parenthesis of line 44. If a delete command was received for “Empire Burlesque” 16 and <TITLE>, </TITLE>, a “2” would be entered into the parenthesis. The next column is the parent line 64 of the current line. Thus the parent line for the line 66 is the first line containing the tag CATALOG. If you count the lines you will see that this is line five (5) or the preceding line. The last column of formatting characters is a p-level 68. The p-level 68 is the first new tag opened but not closed. Thus at line 44, which corresponds to the data entry “Empire Burlesque” 16, the first new tag opened is CATALOG. In addition the tag CATALOG is not closed. Thus the p-level is two (2).

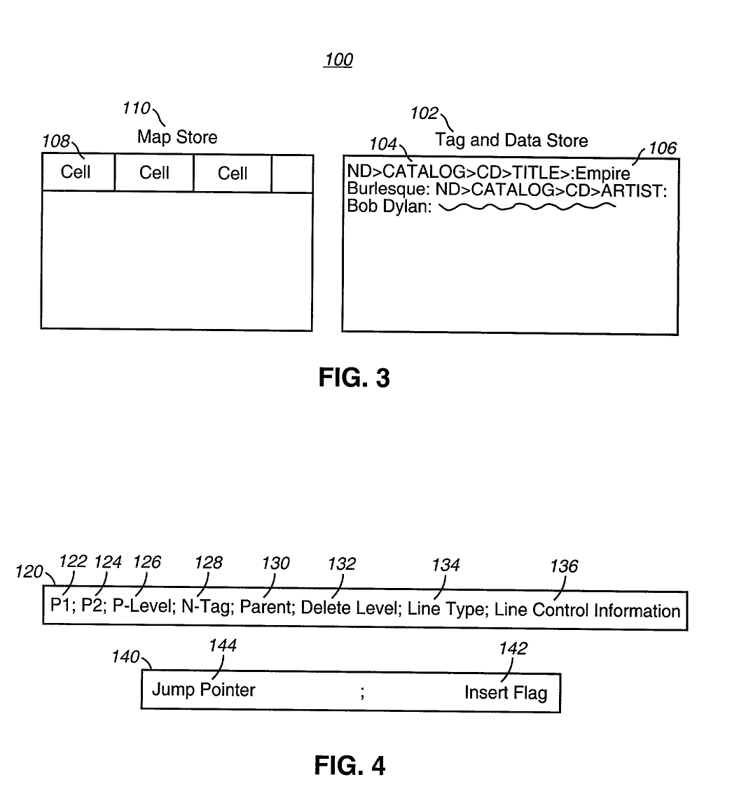

FIG. 3 is a block diagram of a system 100 for storing a flattened data document in accordance with one embodiment of the invention. Once the structured data document is flattened as shown in FIG. 2, it can be stored. Each unique tag or unique set of tags for each line is stored to a tag and data store 102. The first entry in the tag and data store is ND>CATALOG>CD>TITLE> 104. Next the data entry “Empire Burlesque” 106 is stored in the tag and data store 102. The pointers to the tag and data entry in the tag and data store 102 are substituted into line 44. Updated line 44 is then stored in a first cell 108 of the map store 110. In one embodiment the tag store and the data store are separate. The tag and data store 102 acts as a dictionary, which reduces the required memory size to store the structured data document. Note that the formatting characters allow the structured data document to be completely reconstructed.

FIG. 4 shows two examples of a map store cell in accordance with one embodiment of the invention. The first example 120 works as described above. The cell 120 has a first pointer (P₁) 122 that points to the tag in the tag and data store 102 and a second pointer (P₂) 124 that points to the data entry. The other information is the same as in a flattened line such as: p-level 126; n-tag 128; parent 130; delete level 132; line type 134; and line control information 136. The second cell type 140 is for an insert. When an insert command is received a cell has to moved. The moved cell is replaced with the insert cell 140. The insert cell has an insert flag 142 and a jump pointer 144. The moved cell and the inserted cell are at the jump pointer.

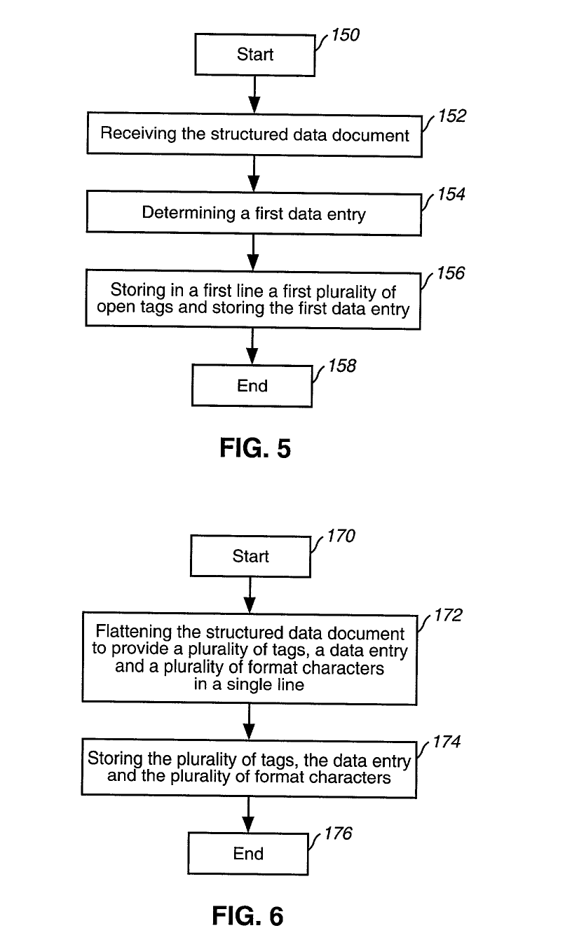

FIG. 5 is a flow chart of a method of storing a structured data document. The process starts, step 150, by receiving the structured data document at step 152. A first data entry is determined at step 154. In one embodiment, the first data entry is an empty data slot. At step 156 a first plurality of open tags and the first data entry is stored which ends the process at step 158. In one embodiment a level of a first opened tag is determined. The level of the first opened tag is stored. In another embodiment, a number of consecutive tags closed after the first data entry is determined. This number is then stored. A line number is stored.

In one embodiment, a next data entry is determined. A next plurality of open tags proceeding the next data entry is stored. These steps are repeated until a next data entry is not found. Note that the first data entry may be a null. A plurality of format characters associated with the next data entry are also stored. In one embodiment the flattened data document is expanded into the structured data document using the plurality of formatting characters.

FIG. 6 is a flow chart of a method of storing a structured data document. The process starts, step 170, by flattening the structured data document to a provide a plurality of tags, a data entry and a plurality of format characters in a single line at step 172. At step 174 the plurality of tags, the data entry and the plurality of format characters are stored which ends the process at step 176. In one embodiment, the plurality of tags are stored in a tag and data store. In addition, the plurality of format characters are stored in map store. The data entry is stored in the tag and data store. A first pointer in the map store points to the plurality of tags in the tag and data store. A second pointer is stored in the map store that points to the data store. In one embodiment, the structured data document is received. A first data entry is determined. A first plurality of open tags proceeding the first data entry and the first data entry are placed in a first line. A next data entry is determined. A next plurality of open tags proceeding the next data entry is placed in the next line. These steps are repeated until a next data entry is not found. In one embodiment a format character is placed in the first line. In one embodiment the format character is a number that indicates a level of a first tag that was opened. In one embodiment the format character is a number that indicates a number of tags that are consecutively closed after the first data entry. In one embodiment the format character is a number that indicates a line number of a parent of a lowest level tag. In one embodiment the format character is a number that indicates a level of a first tag that was opened but not closed. In one embodiment the format character is a character that indicates a line type. In one embodiment the format character indicates a line control information. In one embodiment the structured data document is an extensible markup language document. In one embodiment the next data entry is placed in the next line.

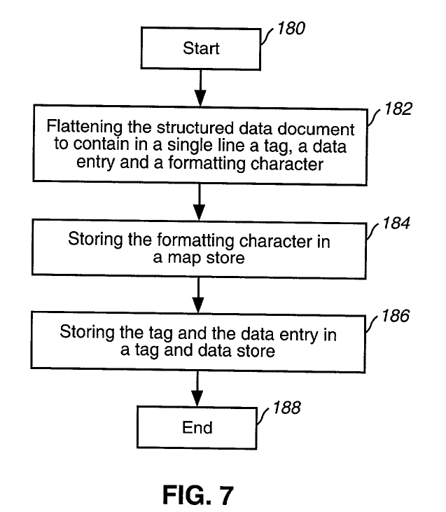

FIG. 7 is a flow chart of a method of storing a structured data document. The process starts, step 180, by flattening the structured data document to contain in a single line a tag, a data entry and a formatting character at step 182. The formatting character is stored in a map store at step 184. At step 186 the tag and the data entry are stored in a tag and data store which ends the process at step 188. In one embodiment a first pointer is stored in the map store that points to the tag in the tag and data store. A second pointer is stored in the map store that points to the data entry in the tag and data store. In one embodiment a cell is created in the map store for each of the plurality of lines in a flattened document. A request is received to delete one of the plurality of data entries. The cell associated with the one of the plurality of data entries is determined. A delete flag is set. Later a restore command is received. The delete flag is unset. In one embodiment, a request to delete one of a plurality of data entries and a plurality of related tags is received. A delete flag is set equal to the number of the plurality of related tags plus one. In one embodiment, a request is received to insert a new entry. A previous cell containing a proceeding data entry is found. The new entry is stored at an end of the map store. A contents of the next cell is moved after the new entry. An insert flag and a pointer to the new entry is stored in the next cell. A second insert flag and second pointer is stored after the contents of the next cell.

Thus there has been described a method of flattening a structured data document. The process of flattening the structured data document generally reduces the number lines used to describe the document. The flattened document is then stored using a dictionary to reduce the memory required to store repeats of tags and data. In addition, the dictionary (tag and data store) allows each cell in the map store to be a fixed length. The result is a compressed document that requires less memory to store and less bandwidth to transmit.

The methods described herein can be implemented as computer-readable instructions stored on a computer-readable storage medium that when executed by a computer will perform the methods described herein.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of storing a structured data document, comprising the steps of:
a) flattening the structured data document to provide a plurality of tags, a data entry and a plurality of format characters in a single line; and
b) storing the plurality of tags, the data entry and the plurality of format characters.

2. The method of claim 1, wherein step (b) further includes the steps of:
b1) storing the plurality of tags in a tag and data store;
b2) storing the plurality of format characters in a map store.

3. The method of claim 2, further including the steps of:
b3) storing the data entry in the tag and data store;
b4) storing a first pointer in the map store that points to the plurality of tags in the tag and data store;
b5) storing a second pointer in the map store that points to the data entry in the tag and data store.

4. The method of claim 1, wherein step (a) further includes the steps of:
a1) receiving the structured data document;
a2) determining a first data entry;
a3) placing in a first line a first plurality of open tags proceeding the first data entry and the first data entry;
a4) determining a next data entry; and
a5) placing a next plurality of open tags proceeding the next data entry in a next line.

5. The method of claim 4, further including the steps of:
a6) repeating steps (a4) and (a5) until a next data entry is not found.

6. The method of claim 4, wherein step (a3) further includes the step of:
i) placing a format character in the first line.

7. The method of claim 4, wherein step (a3) includes the step of:
i) placing in the first line, a number that indicates a level of a first tag that was opened.

8. The method of claim 4, wherein step (a3) includes the step of:
i) placing in the first line, a number that indicates a number of tags that are consecutively closed after the first data entry.

9. The method of claim 4, wherein step (a3) includes the step of:
i) placing in a first line, a number that indicates a line number of a parent of a lowest level tag.

10. The method of claim 4, wherein step (a3) includes the step of:
i) placing in the first line, a number that indicates a level of a first tag that was opened but not closed.

11. The method of claim 4, wherein step (a3) includes the step of:
i) placing in the first line, a character that indicates a line type.

12. The method of claim 4, wherein step (a3) includes the step of:
i) placing in the first line, a character that provides line control information.

13. The method of claim 4, wherein step (a1) further includes the step of:
i) receiving an extensible markup language document.

14. The method of claim 4, wherein step (a4) further includes the steps of:
i) determining a format character.

15. The method of claim 4, further including the step of:
a6) placing the next data entry in the next line.

16. A method of flattening a structured data document, comprising the steps of:
a) receiving the structured data document;
b) determining a first data entry; and
c) storing in a first line a first plurality of open tags and storing the first data entry.

17. The method of claim 16, further including the steps of:
d) determining a level of a first opened tag;
e) storing the level of the first opened tag in the first line.

18. The method of claim 16, further including the steps of:
d) determining a number of consecutive tags closed after the first data entry;
e) storing the number in the first line.

19. The method of claim 16, further including the steps of:
d) storing a line number.

20. The method of claim 16, further including the steps of:
d) determining a next data entry;
e) storing a next plurality of open tags proceeding the next data entry in a next line;
f) repeating steps (d) and (e) until a next data entry is not found.

21. The method of claim 16, wherein step (b) further includes the step of:
b1) determining that the first data entry is a null.

22. The method of claim 20, wherein step (e) further includes the steps of:
e1) storing a plurality of format characters associated with the next data entry.

23. The method of claim 20, further including the steps of:
g) expanding a flattened data document into the structure data document using a plurality of formatting characters.

24. A method of storing a structured data document, comprising the steps of:
a) flattening the structured data document to contain in a single line a tag, a data entry and a formatting character;
b) storing the formatting character in a map store; and
c) storing the tag and the data entry in a tag and data store.

25. The method of claim 24, further including the step of:
d) storing a first pointer in the map store that points to the tag in the tag and data store;
e) storing a second pointer in the map store that points to the data entry in the tag and data store.

26. The method of claim 24, further including the step of:
d) creating a cell in the map store for each of a plurality of lines in a flattened document.

27. The method of claim 26, further including the steps of:
f) receiving a request to delete one of a plurality of data entries;
g) determining the cell associated with the one of the plurality of data entries;
h) setting a delete flag.

28. The method of claim 27, further including the steps of:
i) receiving a restore command;
j) unsetting the delete flag.

29. The method of claim 26, further including the steps of:
f) receiving a request to delete one of a plurality of data entries and a plurality of related tags;
g) setting a delete flag equal to the number of the plurality of related tags plus one.

30. The method of claim 24, further including the steps of:
d) receiving a request to insert a new entry;
e) finding a previous cell containing a proceeding data entry;
f) storing the new entry at an end of the map store;
g) moving a contents of a next cell after the new entry;
h) storing an insert flag and a pointer to the new entry in the next cell.

30. The method of claim 30, further including the step of:
i) storing a second insert flag and a second pointer after the contents of the next cell.
